(19) United States
(12) Patent Application Publication
(10) Pub. No.: US 2014/0245411 A1
(43) Pub. Date: Aug. 28, 2014

(54) METHOD AND APPARATUS FOR PROVIDING ACCOUNT-LESS ACCESS VIA AN ACCOUNT CONNECTOR PLATFORM

(71) Applicant: NOKIA CORPORATION, Espoo (FI)

(72) Inventors: LEI MENG, Oulu (FI); VILLE VILLE, Oulu (FI)

(73) Assignee: NOKIA CORPORATION, Espoo (FI)

(21) Appl. No.: 13/774,559

(22) Filed: Feb. 22, 2013

(51) Int. Cl. H04L 29/06

(52) U.S. Cl. CPC H04L 63/08
USPC 726/7

(57) ABSTRACT

An approach is provided for account-less access via an account connector platform. The account connector platform determines a request from at least one client for a user login to at least one of a plurality of accounts associated with a user. The plurality of accounts is associated with an account connector platform and the request includes, at least in part, one or more credentials for the least one of the plurality of user accounts. The account connector platform causes, at least in part, an association of an account connector token with the user, the at least one of the plurality of accounts, or a combination thereof based, at least in part, on an authentication of the one or more credentials. The account connector platform then determines to authenticate the at least one client to provide another user login to at least another one of the plurality of accounts is based, at least in part, on the account connector token.

### BACKGROUND

Service providers and device manufacturers are continually challenged to deliver value and convenience to consumers by, for example, providing a suite of compelling network services. Many such network services traditionally involve authenticating users during a user sign-on process. In some cases, network resources are wasted and user experience is diminished when a user is required to sign-on several times to participate in multiple services. Thus there is a move to allow a user to sign-on once and thereby gain access to several services from the same provider. For example, an account connector platform may be used to aggregate multiple user accounts to enable single sign-on to those accounts. However, such account connector platforms often rely on their own account sign-on processes, which can potentially add another layer of account authentication to access aggregated accounts, thereby further reducing the user experience. Therefore, service providers face significant technical challenges to improving the user experience when interacting with account connector platforms.

### SOME EXAMPLE EMBODIMENTS

Therefore, there is a need for an approach for providing account-less access to services aggregated via an account connector platform.

According to one embodiment, a method comprises determining a request from at least one client for a user login to at least one of a plurality of accounts associated with a user. The plurality of accounts is associated with an account connector platform and the request includes, at least in part, one or more credentials for the least one of the plurality of user accounts. The method also comprises causing, at least in part, an association of an account connector token with the user, the at least one of the plurality of accounts, or a combination thereof based, at least in part, on an authentication of the one or more credentials. The method further comprises determining to authenticate the at least one client to provide another user login to at least another one of the plurality of accounts is based, at least in part, on the account connector token.

According to another embodiment, an apparatus comprising at least one processor, and at least one memory including computer program code for one or more computer programs, the at least one memory and the computer program code configured to, with the at least one processor, cause, at least in part, the apparatus to determine a request from at least one client for a user login to at least one of a plurality of accounts associated with a user. The plurality of accounts is associated with an account connector platform and the request includes, at least in part, one or more credentials for the least one of the plurality of user accounts. The apparatus also causes, at least in part, an association of an account connector token with the user, the at least one of the plurality of accounts, or a combination thereof based, at least in part, on an authentication of the one or more credentials. The apparatus is further caused to determine to authenticate the at least one client to provide another user login to at least another one of the plurality of accounts is based, at least in part, on the account connector token.

According to another embodiment, a computer-readable storage medium carrying one or more sequences of one or more instructions which, when executed by one or more processors, cause, at least in part, an apparatus to determine that a user has been authenticated for an access to at least one service using a federated identity. The federated identity is associated with the at least one service, at least one or more other services, or a combination thereof. The apparatus is also caused to determine a request from at least one client for a user login to at least one of a plurality of accounts associated with a user. The plurality of accounts is associated with an account connector platform and the request includes, at least in part, one or more credentials for the least one of the plurality of user accounts. The apparatus also causes, at least in part, an association of an account connector token with the user, the at least one of the plurality of accounts, or a combination thereof based, at least in part, on an authentication of the one or more credentials. The apparatus is further caused to determine to authenticate the at least one client to provide another user login to at least another one of the plurality of accounts is based, at least in part, on the account connector token.

According to another embodiment, an apparatus comprises means for determining a request from at least one client for a user login to at least one of a plurality of accounts associated with a user. The plurality of accounts is associated with an account connector platform and the request includes, at least in part, one or more credentials for the least one of the plurality of user accounts. The apparatus also comprises means for causing, at least in part, an association of an account connector token with the user, the at least one of the plurality of accounts, or a combination thereof based, at least in part, on an authentication of the one or more credentials. The apparatus further comprises determining to authenticate the at least one client to provide another user login to at least another one of the plurality of accounts is based, at least in part, on the account connector token.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing account-less access via an account connector platform, according to one embodiment;

FIG. 2 is a diagram of the components of an account connector platform, according to one embodiment;

FIG. 3 is a diagram depicting use of an account-less connector platform for direct login to a service, according to one embodiment;

FIG. 4 is a time sequence diagram for using an account connector token to perform a browser-based login flow, according to one embodiment;

FIG. 5 is a diagram depicting use of an account-less connector platform for key-chain account retrieval, according to one embodiment;

FIG. 6 is a diagram depicting a process for performing a challenge authentication via an account connector platform, according to one embodiment;

FIG. 7 is a diagram depicting a process for encrypting an account connector token, according to one embodiment;

FIG. 8 is a flowchart of a process for providing account-less access via an account connector platform, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing account-less access via an account connector platform are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

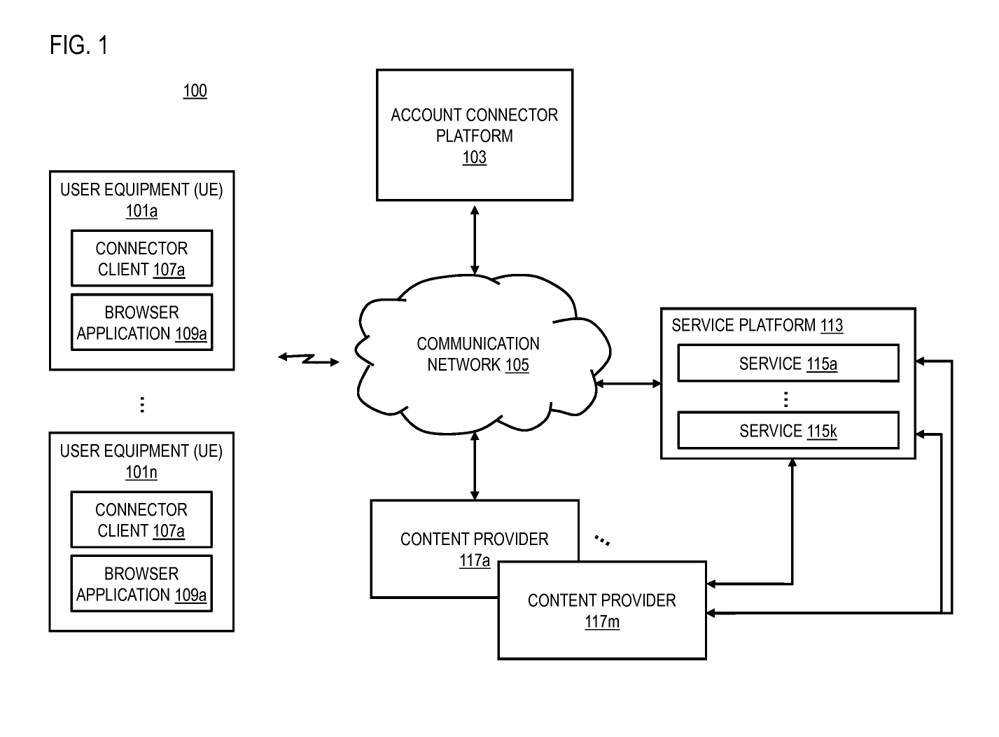

FIG. 1 is a diagram of a system capable of providing account-less access via an account connector platform, according to one embodiment. As shown in FIG. 1, the system 100 comprises one or more user equipment (UEs) 101a-101n (also collectively referred to as UEs 101) having connectivity to an account connector platform 103 via a communication network 105. In one embodiment, the account connector platform 103 performs the various embodiments of the processes for providing account-less access to services as described herein. In addition, the UEs 101 are associated with respective connector client applications 107a-107n (also collectively referred to as connector clients 107) and browser applications 109a-109n (also collectively referred to as browser applications 109) for interacting with the account connector platform 103 and/or performing one or more functions of the account connector platform 103.

In one embodiment, the account connector platform 103 is a backend system designed to aggregate multiple services from a variety of service providers and offer common functions of those services abstracted, for instance, as a set of Representational State Transfer (REST) Application Programming Interfaces (APIs) that are exposed to the connector clients 107 and/or the browser applications 109. By way of example, the connector clients 107 or other client applications running on different platforms can use the stable and abstracted REST APIs to interact with a service platform 113 including one or more services 115a-115k (also collectively referred to as services 115). Example services 115 include social networking services, media services, content or file management services, navigation services, etc. that can be control using a cable-based interface. In some embodiments, the service platform 113 and/or the services 115 have connectivity to content providers 117a-117m for access to content data (e.g., songs, images, videos, mapping data, routing data, etc.).

In one embodiment, the account connector platform 103 aggregates multiple social networking service providers and provide commonly needed social network functions via REST APIs to the connector clients 107 and/or the browser applications. Although various embodiments are discussed with respect to an account connector platform 103 that aggregates social networking services, it is contemplated that the various embodiments described herein are applicable to any type of service 115.

As noted previously, traditional implementations of account connector platforms 103 often rely on platform-specific accounts for authenticating users. In other words, to access the service aggregating functions of the account connector platforms 103, a user creates an account to store and access aggregated account information. Accordingly, only users authenticated by the account connector platform 103 can use services 115 (e.g., to publish/retrieve personal data to/from social networks in the case of social networking services). This brings in a usability problem on UEs 101 using the account connector platform 103. For example, before login to a service 115 aggregated by the account connector platform 103 (e.g., social networking services), a user has to first login to with an account specific to the account connector platform 103. If no existing account connector platform 103 account exists for the user, the user has to go through the account creation process for the platform 104. In some cases, the user may not understand the purpose of account connector platform 103 account login and thus, may be reluctant to go through the extra step of account creation/login before using aggregated services 115. This may lead to a poor user experience and lower utilization rates for the account connector platform 103 and its associated services 115.

Also there is an associated problem with the use of an account connector platform 103 account. In one embodiment, the account connector platform 103 has a “key-chain” feature where user's identities from third party services 115 are linked against his/her account with the account connector platform 103 (e.g., via a user ID specific to the account connector platform 103). For example, this means that when using a new device, a user needs to log into the same account connector platform 103 account and then take the associated third party identities into use without additional logins to third parties. Traditionally, without an account connector platform 103 account, such key-chain function is not available for users. Accordingly, service providers face significant technical challenges to provide account-less access to third party services aggregated by the account connector platform 103.

To address these problems, the system 100 introduces a new approach for authenticating a user before the user can use aggregated services 115 via the account connector platform 103. In one embodiment, creation of a user account with the account connector platform 103 as a user authentication service is made optional. In one embodiment, the system 100 enables a user or UE 101 to directly login to a selected third party service 115 (e.g., a social networking service) to authenticate him/herself. As a result of successful login to a third party service 115, a user could also retrieve his/her key-chain to a new UE 101 and start using the third party services 115 right away without having to login again to each service 115. In one embodiment, the account connector platform 103 offers its clients 107 a generic way for getting account connector platform 103 access token regardless of what user authentication flows are used. In this way, the clients 107 have a consistent way of interacting with REST APIs exposed by the account connector platform 103.

As previously described, in one embodiment, the account connector platform 103 is a gateway that aggregates commonalities of services 115 (e.g., social networking services) and offer commonly used service functions (e.g., social networking services) through a set of stable REST APIs to the clients 107 for easily interacting with multiple services. In one embodiment, such a gateway server system is based on the identification/authentication of a user or UE 101 that is using APIs exposed by the account connector platform 103 to interact with aggregated services 115 (e.g., social networks). Traditionally, specific users accounts created in the account connector platform 103 have been the primary user authentication system for the platform 103. In this system, the client 107 to presents a token generated by the account connector platform 107 in requests (e.g., service requests) to the platform 103. Only after the token is verified can the account connector platform 103 serve the request. If a user successfully logs into a service 115 aggregated through the account connector platform 103, the user credentials (e.g., user ID and token) returned by that service 115 will be linked against the user's account ID associated with the account connector platform 103 as decrypted from the user's token presented in the request.

In one embodiment, the account connector platform 103 removes the requirement to create or login to a user account specific to the account connector platform 103. However, when improving the user experience by removing the step of account connector platform 103 account login, the account connector platform 103 will not have a dedicated internal service for authenticating its users. In the various embodiments described herein, the account connector platform 103 delegates the task of authenticating users to the services 115 (e.g., social networking service providers). By way of example, most contemporary internet service providers use OAuth 1.0 or OAuth 2.0 as the standard for user authentication. Accordingly, the various embodiments are described using the OAuth 1.0 or OAuth 2.0 standards. However, it is contemplated that the various embodiments of the approach described herein are also applicable to other user authentication standards and/or protocols.

In one embodiment, to ease up the integration work for implementing the clients 107, the account connector platform 103 makes sure that the way of accessing its REST APIs remains consistent with past practices. For example, instead of presenting an account generated token in the request, the client 107 presents a token generated by the account connector platform 103. As a result, in one embodiment, when to generate an account connector platform 103 token and how to make it available to the client 107 becomes an issue to be addressed. Essentially, in one embodiment, for security and/or privacy considerations, the account connector platform 103 cannot let clients 107 freely access its APIs for handling user's personal data. In one scenario, the token is generated after the user has been authenticated by a selected service 115. Then, the account connector platform 103 can return a token to client 107 directly as a response to a service login request. This approach is compatible with services 115 that offer direct login APIs (e.g., OAuth 2.0 resource owner password credentials flow).

However, this approach can be problematic for services 115 that mandate browser-based login flows (e.g. OAuth 2.0 authorization code flow or OAuth 1.0 flow). For example, in one embodiment, the client 107 can launch a browser 109 to initiate a login flow against a selected service 115 with the account connector platform 103 facilitating the browser redirection defined by the standard. Although the account connector platform 103 knows about the completion of such browser login flow and would be able to create an account connector platform 103 token then, there is no consistent way of returning the token back to client 107 in this case.

Accordingly, in one embodiment, the account connector platform 103 offers a dedicated endpoint for a client 107 to get a platform 103 token even without any user authentication. For example, this endpoint authenticates the calling application (e.g., the client 107) and then returns a platform 103 token to the client 107. With the connector token, the client 107 can start using, for instance, the account connector platform 103 service activation endpoint to perform user login to services 115 (e.g., social networking services) using whatever flows (browser-based or direct) are associated with the respective services 115. In one embodiment, after a user or UE 101 has logged into a selected service 115, the credentials (e.g., user ID and token) returned by service provider is linked with the user ID that the application connector platform 103 generated when creating the token. In one embodiment, once the linkage between the user's third party service identity and the application connector platform 103 created identity is established, the platform 103 token received by the client 107 previously starts to become “meaningful”. In practice, it means that now the client 107 can start publishing/retrieving user's personal data to/from various services 115 (e.g., social networking services) through the account connector platform 103. In some embodiments, as part of this process, user's key-chain is created and maintained on the account connector platform 103 server side. In this way, when a user activates a UE 101 or initializes the UE 101, this key-chain can be retrieved by login to any of the previously used third party services 115.

In one embodiment, the account connector platform 103 supports both the third party service 115 based user authentication and platform 103 account based user authentication at the same time. For example, the client 107 can choose either of the two authentication processes when integrating with the account connector platform 103. It is further contemplated that account connector platform 103 can adopt any new user authentication service providers if the client 107 so decides. In one embodiment, as long as the new user authentication service provider grants the client 107 some form of access token and arranges the token verification mechanism with the account connector platform 103 beforehand, the client 107 can use APIs exposed by the account connector platform 103 in the same way by just passing in the access token generated by the new user authentication service provider.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the account connector platform 103, the clients 107, the browser applications 109, the service platform 113, the services 115, and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the account connector platform 103 and the clients 107 can interact according to a client-server model. It is noted that the client-server model of computer process interaction is widely known and used. According to the client-server model, a client process sends a message including a request to a server process, and the server process responds by providing a service. The server process can also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

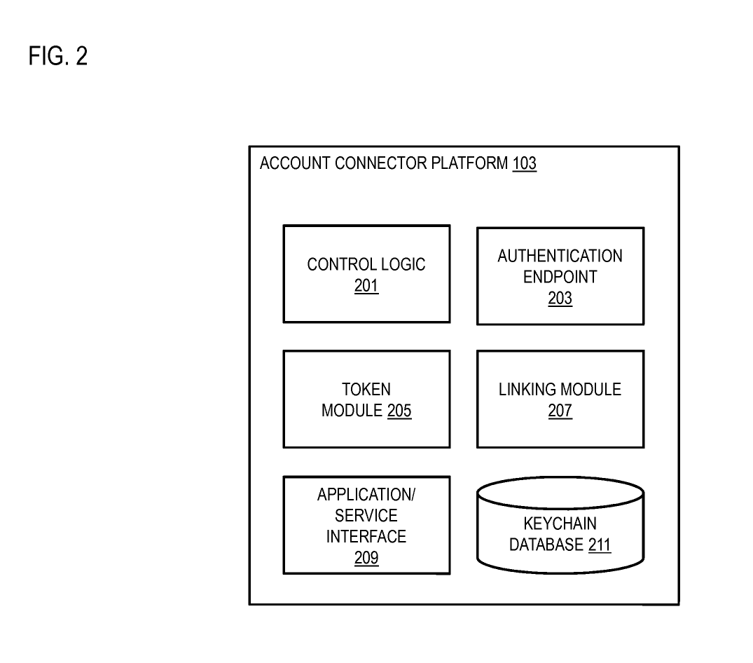

FIG. 2 is a diagram of the components of an account connector platform, according to one embodiment. By way of example, the account connector platform 103 includes one or more components for providing account-less access to various functions of the services 115. In one embodiment, the connector client 107 can perform all or a portion of the functions of the account connector platform 103 in addition to or in place of the platform 103. In one embodiment, the account connector platform 103 represents one or more server side components, and the connector clients 107 represent one or more client side (e.g., UE 101 side) components for providing account-less access to the platform 103 and associated aggregated services 115. It is contemplated that the functions of these components may be combined in one or more components or performed by other components of equivalent functionality. In this embodiment, the account connector platform 103 includes a control logic 201, an authentication endpoint 203, a token module 205, a linking module 207, an application/service interface 209, and a keychain database 211.

In one embodiment, the control logic 201 executes one or more algorithms for providing account-less access to services 115 via the account connector platform 103. By way of example, the control logic 201 interacts with the authentication endpoint 203 to authenticate access by clients 107, browsers 109, and/or other applications seeking to access the functions of the platform 103. As previously described, the authentication endpoint 203 operates by authenticating the clients 107 rather than users for access to the platform 103, therefore no user authentication is performed during the client 107 authentication process. For example, the authentication module 203 can use any authentication process or mechanism to ensure that a requesting client 107 or application is authorized to access the platform 103.

After authenticating the client 107, the authentication module 203 interacts with the token module 205 to deliver or otherwise activate a connector token that is associated with the authenticated client 107. In one embodiment, the token module 203 may generate the connector token after the authentication module 203 confirms the authentication of the client 107. It is noted that, in this embodiment, the connector token for the authenticated client 107 does not have any user identifiable information. Instead, the token can be based on an identity generated by the token module that can act as a representative or shadow identity (e.g., not tied to any specific user) for prospective users. For example, when the connector token is bound or linked to specific user credentials for selected services 115, the connector then is associated with specific user information. Additional details of the authentication process and token generation process are described further below.

In one embodiment, it is contemplated that the authentication and token generation process can be performed at any stage of operation of the client 107. For example, the authentication process and token generation process may be initiated when the client 107 makes a login request to one or more of the services available via the platform 103. In other embodiments, the authentication and/or the token generation process may occur prior to a request by the client 107. For example, one or more connector tokens can be generated and pre-stored at the client 107 in anticipation of user service requests.

After the connector token is generated and associated with the client 107, the linking module 207 can monitor for when the client 107 requests a login to a selected service 115 aggregated by the platform 103. For example, the linking module 207 can determine when a request to the platform 103 includes account credentials to a selected service 115. The linking module 207 can then initiate authentication of those service credentials through one or more flows (e.g., browser-based or direct login) established for the selected service 115. In other words, the provider of the selected service 115 (e.g., a third party service provider) performs the authentication of the service credentials and returns authenticated credentials (e.g., a user ID and service token). In one embodiment, the linking module 207 then links the authenticated service credentials with the connector token previously provided to the client 107. Accordingly, the connector token becomes “meaningful” for the particular user associated with the authenticated service credentials.

On linking the connector token and the authenticated service credentials, the application/service interface 209 enables the client to access service functions (e.g., including accessing personal data associated with those functions) provided by the selected service 115. Through this process, the client 107 can then initiate functions of the selected service 115 through the platform 103.

In one embodiment, the linking module 207 can support the use of key-chained accounts (e.g., aggregated accounts that can interoperate after providing a single set of credentials). These aggregated or key-chained accounts may be stored in the keychain database 211. In this way, if one service account associated with the key-chain is authenticated and associated with the connector token, other accounts in the keychain may be automatically associated with the same connector token to provide federated access to the accounts. In one embodiment, all accounts in the keychain may be associated with the connector token automatically. In other accounts, the linking module 207 may use rules, criteria, preferences, etc. to determine which of the accounts to link to the connector token. In one embodiment, these rules, etc. may specify that certain accounts may be linked only if credentials associated with a specific service 115 are provided. For example, if a user logs in with credentials for a social networking service, the linking module 207 may link only other social networking services in the keychain, and not non-social networking accounts such as financial accounts, email accounts, etc. It is contemplated that any rule, criteria, preferences, etc. may be used to determine which accounts to link in a keychain.

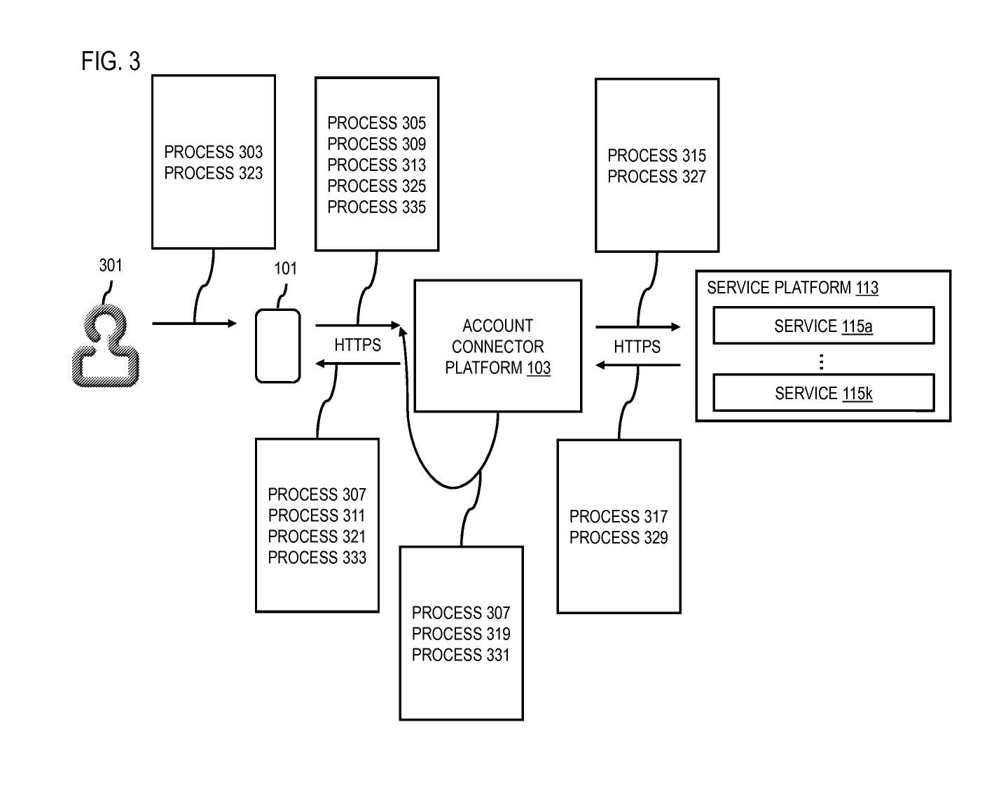

FIG. 3 is a diagram depicting use of an account-less connector platform for direct login to a service, according to one embodiment. In this example, an account connector platform 103 enables a user 301 via a UE 101 configured with a connector client 107 (not shown) to access aggregated third party services 115a-115n of a service platform 113. The processes below describe the interactions among the user 301, the UE 101, the account connector platform 103, the service platform 113, and the services 115a-115n.

In process 303, the user 301 initiates a request to login to a service 115a (e.g., a first social network) at the UE 101. In response, the UE 101 requests a challenge from the account connector platform 103 using, for instance, a secure transport protocol (e.g., HTTPS protocol) (process 305). The account connector platform 103 then returns a challenge to the UE 101 (process 307) for authentication of the client 107 (e.g., executing in the UE 101) with the challenge and an application secret associated with the client 107 (process 309).

The account connector platform 103 verifies the challenge response from the client 107 and generates an account connector token (e.g., including or in addition to an account connector ID). In one embodiment, the account connector platform 103 stores a record of the account connector ID and its associated account connector token, and returns the connector token to the UE 101 (process 311).

The UE 101 (e.g., via the client 107) then sends a login request for the service 115a (e.g., a first social network) to the account connector platform 103 (process 313). By way of example, the request includes the account connector token provided to the UE 101 in process 311. The account connector platform 103 sends the user credentials (e.g., username and password) associated with the user 301 to the service 115a for authentication (process 315).

As previously described, the service 115a may use any authentication mechanism to authenticate the user credentials for access to the service 115a. After a successful authentication, the service 115a returns a service ID and service access token to the account connector platform 103 (process 317). Next, the account connector platform 103 links the service ID and service access token for the service 115a to the connector token associated with the UE 101 (process 319), and returns a message to the UE 101 that the login to the selected service 115a was successful (process 321).

In process 323, the user initiates a request to login for another service 115n (e.g., a second social network) at the UE 101. The UE 101 sends the login request along with its account connector token to the account connector platform 103 (process 325). Similar to the login process for the service 115a, the account connector platform 103 sends the user credentials (e.g., username and password specific to service 115n) associated with the user 301 to the service 115b for authentication (process 327). The service 115n authenticates the credentials and returns a service ID and service access token for the service 115n to the account connector platform 103 (process 329).

The account connector platform 103 links the service ID and service access token for the service 115n to the account connector token of the UE 101 (process 331) and returns a message to the UE 101 to indicate a successful login to the service 115b (process 333). With the service access tokens for both services 115a and 115n linked to the connector token, the account connector platform 103 is able to provide service information (e.g., social network status updates) to the UE 101 (process 335).

In summary, the processes described in the example of FIG. 3 enables a user to directly select a service 115a (e.g., a third party social networking service) and login into that service without having to login an account specific to the account connector platform 103. In this way, the user can start consuming service functions through the account connector platform 103 in an account-less manner.

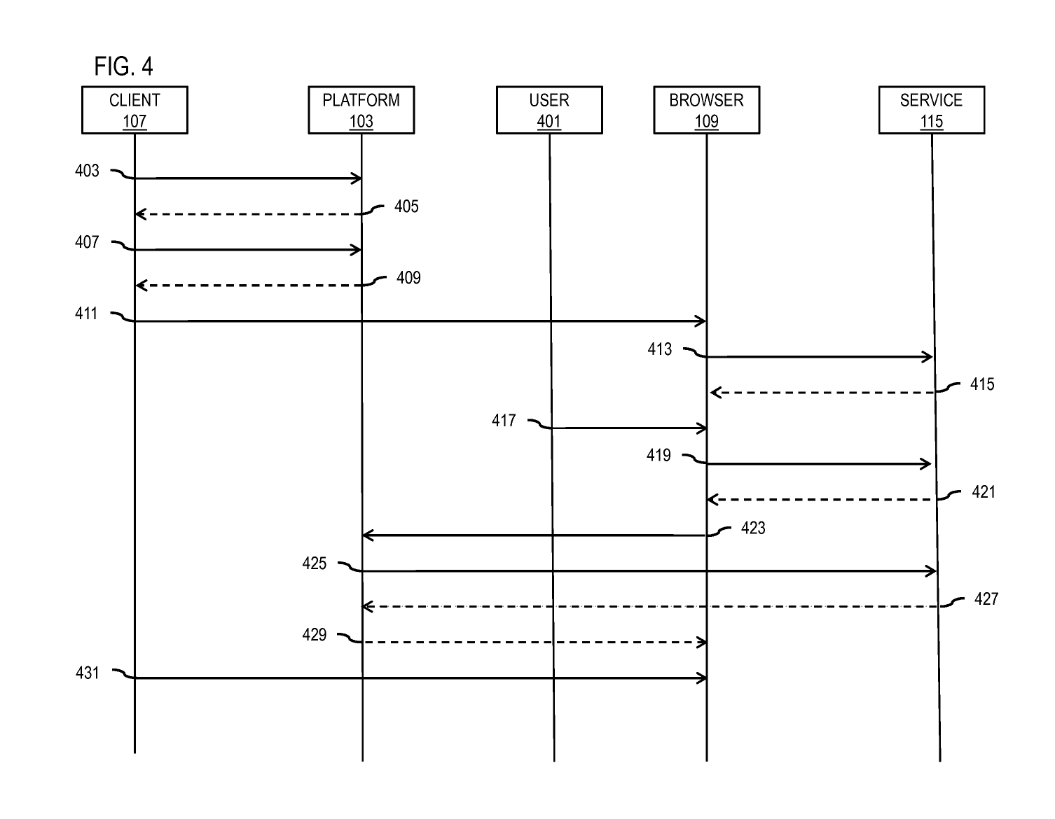

FIG. 4 is a time sequence diagram for using an account connector token to perform a browser-based login flow, according to one embodiment. More specifically, FIG. 4 is a ladder diagram that illustrates a sequence of messages and processes for using an account connector token via OAuth 2.0 service side flow. A network process is represented by a thin vertical line. A step or message passed from one process to another is represented by horizontal arrows. A dashed horizontal arrow represents a response to a message or request. The processes represented in FIG. 4 are a client 107, an account connector platform 103, a user 401, a browser 109, and a service 115.

In step 403, the client 107 initiates a request for an account connector token from the account connector platform 103. The account connector platform 103 returns the requested connector token (e.g., following authentication of the client according to the processes previously described) (step 405). To request a login to a selected service 115, the client 107 initiates a request for a pre-constructed Uniform Resource Locator (URL) with the connector token in the request (step 407). In response to the request, the account connector platform 103 verifies the connector token and returns the requested pre-constructed URL that points to a service provider login for the selected service 115 (step 409).

On receipt of the pre-constructed URL, the client 107 launches the browser application 109 with the pre-constructed service provider URL (step 411). In one embodiment, the client 107 includes all necessary parameters or credentials for initiating the login via the pre-constructed URL. On launch, the browser 109 initiates, for instance, an HTTP GET with the service provider URL (step 413). By way of example, the service 115 responds with a “200 OK” message and returns the service provider login page content for presentation at the browser 109 (step 415).

The browser 109 then renders the login page content for the user 401 so that the user 401 can input the user's service credentials (e.g., username and password) (step 417). The browser 109 transmits the service credentials to the service 115 for third party authentication (step 419). Following authentication at the service 115, the service 115 returns a “302/303” message with a redirect URL and an authorization code (step 421). In this example, the redirect URL points to the account connector platform 103.

The browser 109 transmits an HTTP GET command with the redirect URL and authorization code to the account connector platform 103 (step 423). The account connector platform 103 then takes the authorization code and generates a request to the service 115 for service access tokens based on the authorization code. The service 115 verifies the authorization code in the request from the platform 103 and returns the requested service access tokens to the platform 103 (step 427).

The account connector platform 103 then stores the service access tokens and links the access tokens to the connector token and/or connector ID associated with the user 401. On a successful storage and linking of the service access tokens, the account connector platform 103 transmits a “200 OK” message to the browser 109 (step 429). In step 431, the client 107 detects the end of the authentication flow (e.g., via the receipt of the “200 OK” message at the browser 109) and closes the browser 109.

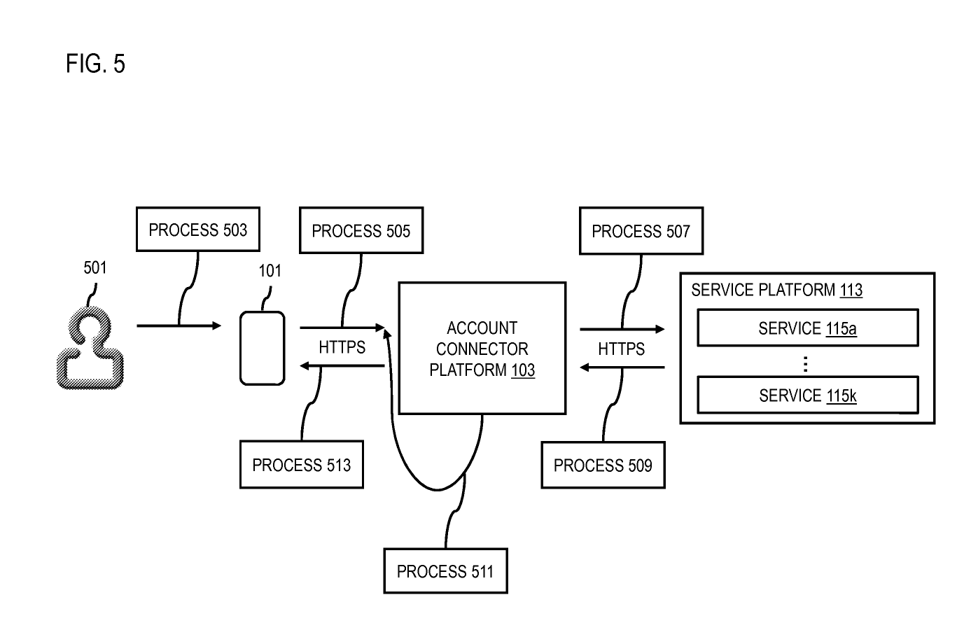

FIG. 5 is a diagram depicting use of an account-less aggregator platform for keychain account retrieval, according to one embodiment. The example of FIG. 5 illustrates a scenario in which a user 501 is activating a new device or has reinitialized a current device so that no keychain account information is present on the device. In this case, the account connector platform 103 enables the user 501 to login to one previously stored third party account associated with a keychain account, and then automatically retrieve the account information for other accounts in the keychain. The keychain retrieval process is described below.

In process 503, the user 501 initiates a request to login to a service 115a (e.g., a social network) at the UE 101. The UE 101 forwards the login request to the account connector platform 103 (process 505). In turn, the account connector platform 103 sends the login request to the selected service 115a for authentication (process 507). On a successful authentication, the service 115a returns the user 501's service ID and service access token to the account connector platform 103.

The account connector platform 103 then determines whether there is an existing service ID and/or service access token previously stored in its keychain database (process 511) and associated with account connector ID or token. If a match is found in the database, the account connector platform 103 retrieves previously used accounts accessed via the platform 103 that are associated with the same account connector ID or token and returns the service tokens for the selected service 115a along with the accounts for other previously used services 115.

In one embodiment, the other services 115 that are returned as part of the keychain retrieval process can depend on the selected service 115a used for authentication. As previously noted, the account connector platform 103 can use rules, criteria, preferences, etc. to determine whether to return all or a portion of the keychain account information based on the selected service 115a.

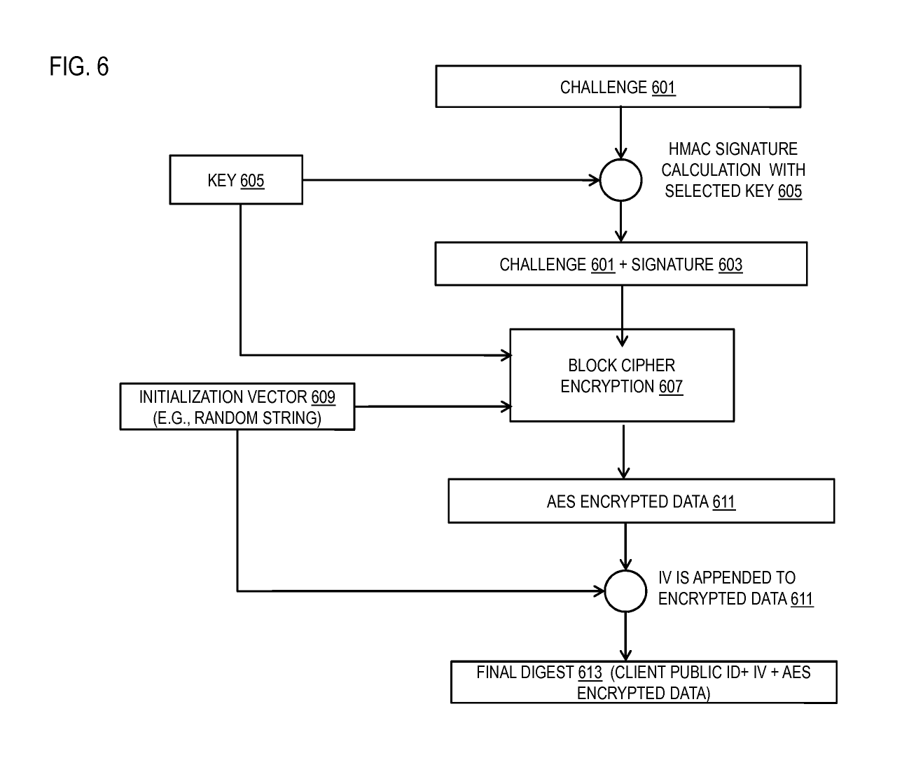

FIG. 6 is a diagram depicting a process for performing a challenge authentication via an account connector platform, according to one embodiment. As previously described, the process for obtaining an account connector token is based on authentication of a client 107 using, for instance, a challenge. For example, the client first gets a challenge from the account connector platform 103. A signature is calculated by using a client 107 secret (e.g., granted by the account connector platform 103 beforehand during, for instance, an auditing process) and challenge. In one embodiment, an ID associated with the client 107 is appended to the signature. Accordingly, the account connector platform 103 can check the validity of the client ID and signature to make sure the client 107 is a trusted client application. Once the validity of the client 107 is confirmed, the account connector platform 103 can return an account connector token to the client 107. For example, after getting the account connector token, the client does not need to provide client identification information in subsequent requests to the platform 103. Moreover, the account connector platform 103 is able to decrypt the connector token and discover which client 107 is using the platform 103 for which user.

An example challenge algorithm and process is illustrated in FIG. 6. In one embodiment, the account connector platform 103 generates a challenge 601 and combines the challenge 601 with a signature 603. In one embodiment, the signature is calculated using a key 605 specific to a client 107. Example client credentials include: e.g., Client ID/Key: “awsdefrgthyjukilopxcvff” and Client Secret: “azxcvbgtrfdewsffggttkiolpuyhgtrf”. More specifically, the platform 103 calculates the signature 603 using, for instance, a Hash-based Message Authentication Code (HMAC) signature calculation that is applied on the key 605. By way of example, in one embodiment, the key 603 serves as the client 107 secret for both the HMAC algorithm and subsequent encryption using, for instance, Advanced Encryption Standard (AES) encryption.

In one embodiment, the block cipher encryption 607 is applied to the challenge 601 and signature 603 using, for instance, an initialization vector 609 to generate AES encrypted data 611. In one embodiment, the initialization vector 609 can be a random string. This initialization vector can then be appended to the resulting AES encrypted data 613 to generate that final digest 613 consisting of the client 107 public ID, AES encrypted data 613, and initialization vector 609).

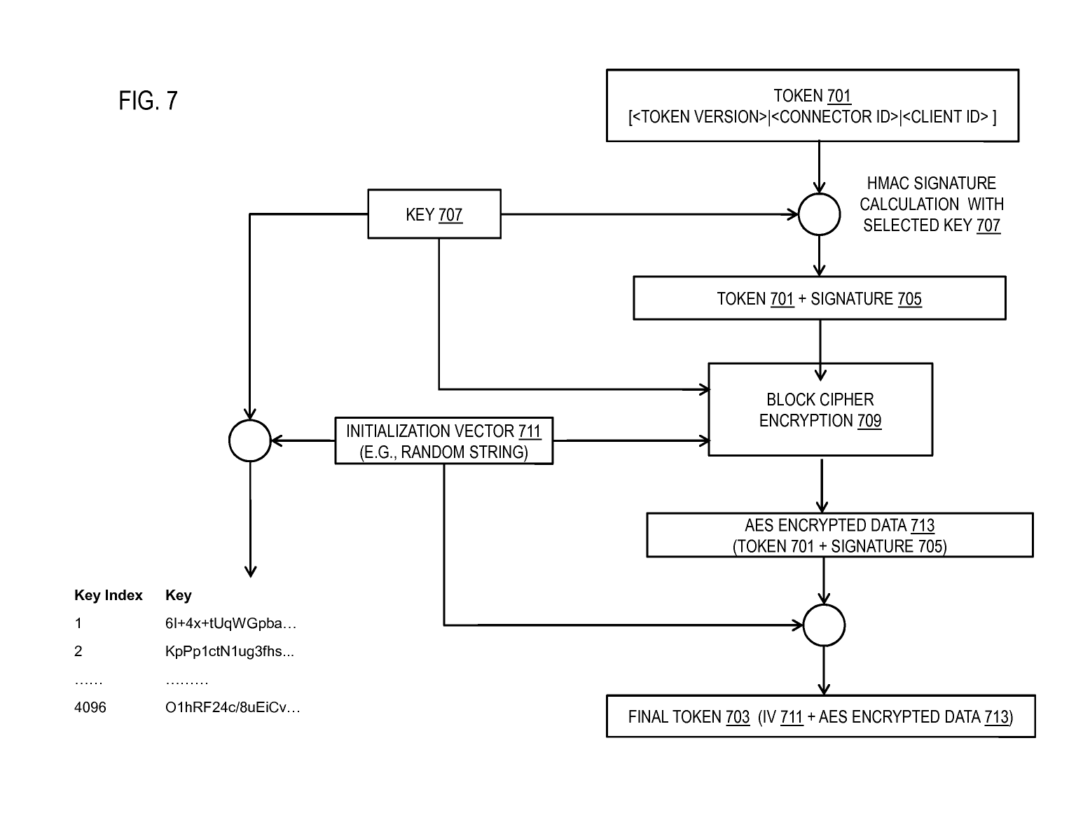

FIG. 7 is a diagram depicting a process for encrypting an account connector token, according to one embodiment. In one embodiment, the account connector platform 103 generates an account connector token 701 for a client 107 during the client 107's first authentication. The client 107 then presents the account connector token 701 in subsequent requests sent after the client authentication. In one embodiment, after a service login is performed correctly, the service ID and service access token for the selected service 115 are linked to the account connector token 701 or a connector ID associated with the token 701. Consequently, the account connector token 701 can be used to access a user's personal data via services 115 aggregated by the account connector platform 103. In one embodiment, the account connector token 701 consists of an account connector ID, a token version, a client ID, and/or a token timestamp (e.g., a token creation time). In one embodiment, the information in the token 701 is not visible to the client 107 but will be used by the account connector platform 103. The client 107 will only see an opaque token 703 that is encrypted.

In one embodiment, the account connector platform 103 encrypts the connector token 701 as shown in FIG. 7. For example, the platform 103 calculates an HMAC signature 705 using a selected key 707. The signature 705 is then added to the token 701. In one embodiment, the key 707 is generated dynamically based on a Salt and client ID. Moreover, the key 707 is different for each individual token 701.

The account connector platform 103 then performs, for instance, an AES 256 encryption using block cipher encryption 709 against the token 701 and signature 705 to generate AES encrypted data 713. In one embodiment, a Salt (e.g., an initialization vector 711 comprised of a random string) is added to the AES encrypted data 713 to generate the final opaque token 703 that can be sent to the client 107.

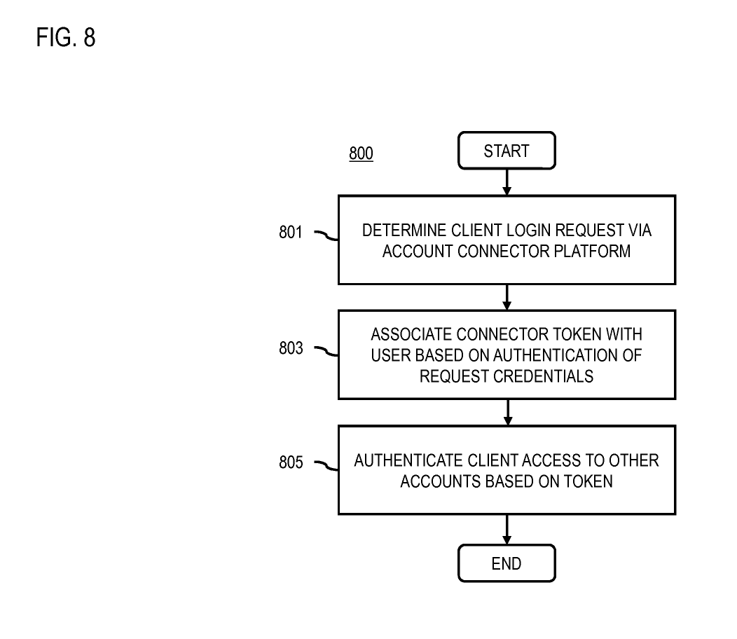

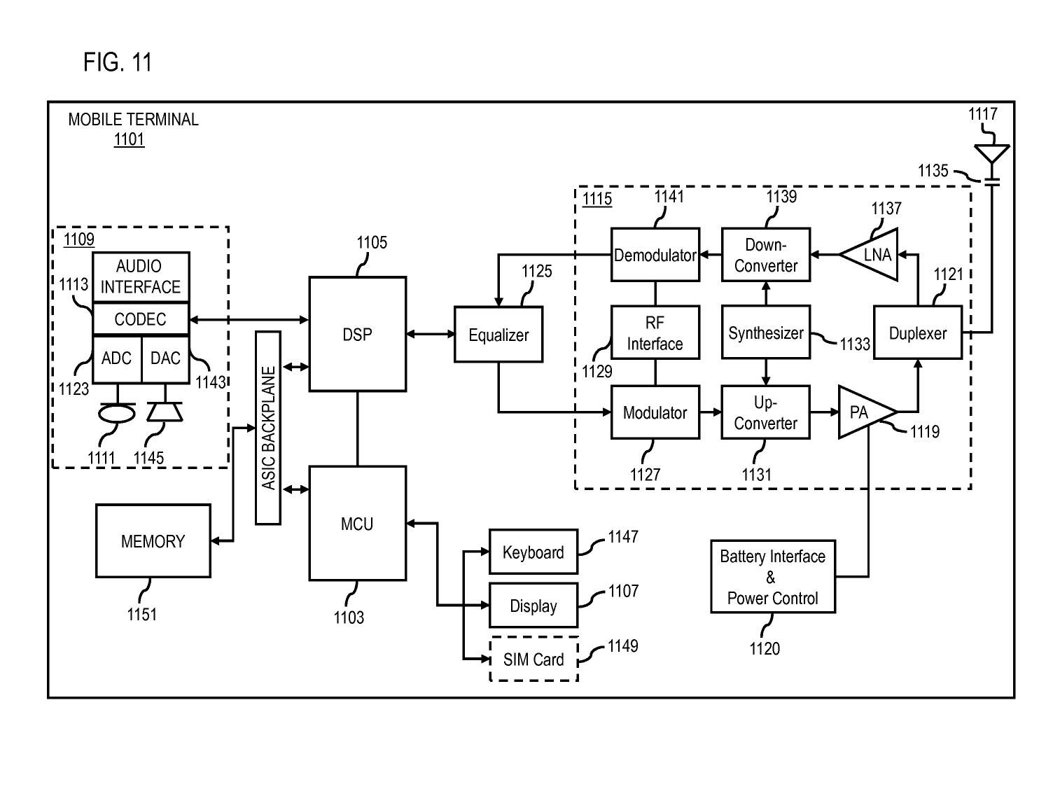

FIG. 8 is a flowchart of a process for providing account-less access via an account connector platform, according to one embodiment. In one embodiment, the account connector platform 103 performs the process 800 and is implemented in, for instance, a chip set including a processor and a memory as shown in FIG. 11. In addition or alternatively, the connector client 107 may perform all or a portion of the process 800.

In step 801, the account connector platform 103 determines a request from at least one client 107 for a user login to at least one of a plurality of accounts associated with a user, wherein the plurality of accounts is associated with the account connector platform 103 and wherein the request includes, at least in part, one or more credentials for the least one of the plurality of user accounts. In one embodiment, the user accounts are associated with one or more services 115 (e.g., social networking services).

In step 803, the account connector platform 103 causes, at least in part, an association of an account connector token with the user, the at least one of the plurality of accounts, services 115, or a combination thereof based, at least in part, on an authentication of the one or more credentials. In one embodiment, the authentication of the one or more credentials, an authentication of the at least one client to provide another user login, or a combination thereof is performed by at least one third party service provider.

In one embodiment, the account connector platform 103 causes, at least in part, a generation of the account connector token based, at least in part, on an authentication of the client 107 for access to the account connector platform 103. In another embodiment, the generation of the account connector token is performed subsequent to the request or the authentication of the one or more credentials. In yet other embodiments, the account connector platform 103 causes, at least in part, a pre-storing of the account connector token at the client prior to the request.

In one embodiment, the association of the account connector token with the user, the at least one of the plurality of accounts, services 115, or a combination thereof includes causing, at least in part, a linking of the account connector token with at least one service token resulting from the authentication of the one or more credentials, an authentication of the at least one client 107 to provide the another user login, or a combination thereof. In one embodiment, the plurality of user accounts are associated with a key-chain account that stores the at least one service token, one or more other service tokens associated with the plurality of user accounts, or a combination thereof.

In step 805, the account connector platform 103 determines to authenticate the at least one client to provide another user login to at least another one of the plurality of accounts is based, at least in part, on the account connector token.

In one embodiment, the account connector platform 103 determines that the login request follows an initialization of the at least one client 107 or associated UE 101. The account connector platform 103 then may cause, at least in part, a restoration of the at least one of the plurality of user accounts, the at least another one of the plurality user accounts, or a combination thereof to the client based, at least in part, on the authentication of the one or more credentials, an authentication of the at least one client to provide another user login, or a combination thereof.

In another embodiment, the account connector platform 103 determines which of the at least another one of the plurality of users accounts to link to the account connector token based, at least in part, on one or more characteristics of the at least one of the plurality of user accounts. By way of example, the one or more characteristics include, at least in part, an account type, a service provider, a privacy policy, a security policy, or a combination thereof.

The processes described herein for providing account-less access via an account connector platform may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

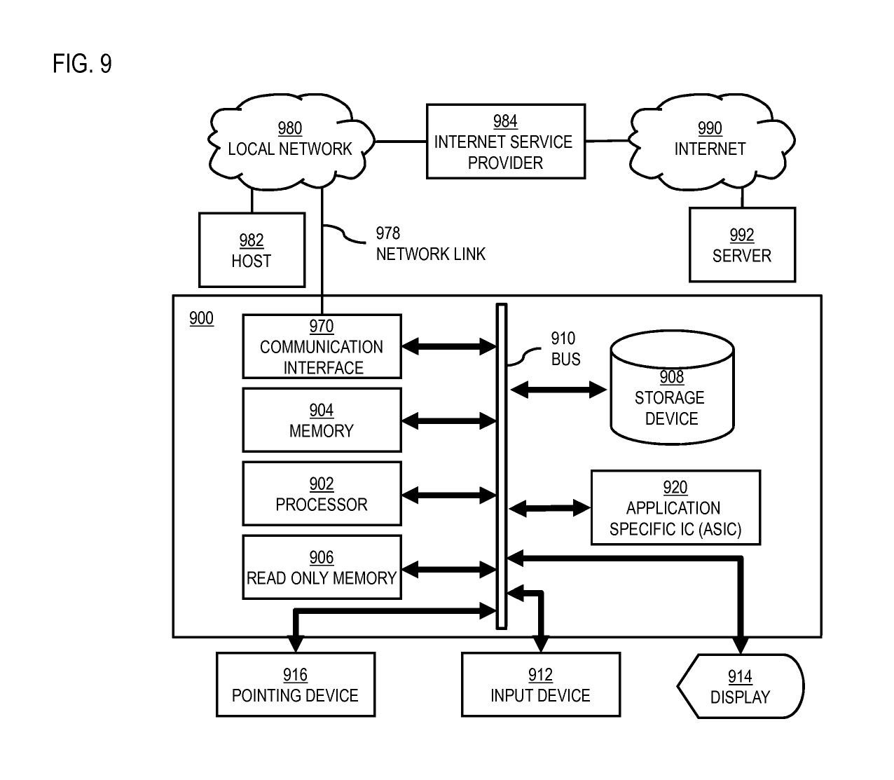

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide account-less access via an account connector platform as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing account-less access via an account connector platform.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing account-less access via an account connector platform. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing account-less access via an account connector platform. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing account-less access via an account connector platform, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing account-less access via an account connector platform to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

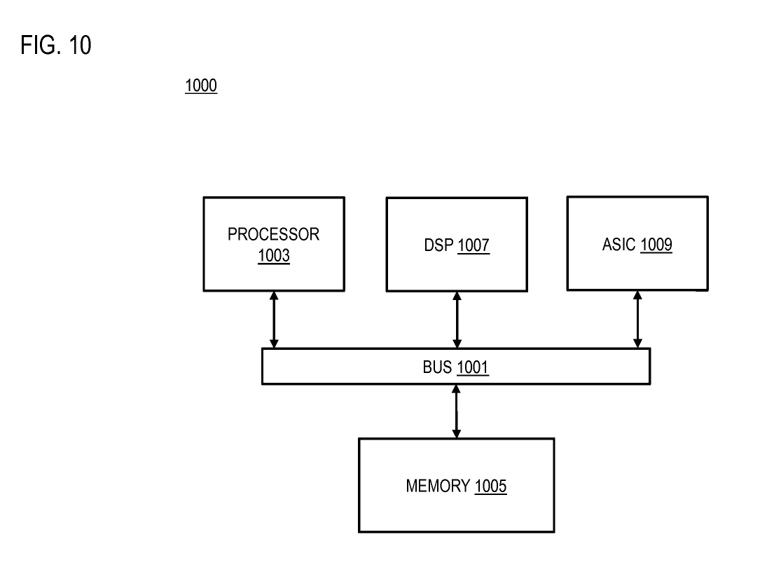

FIG. 10 illustrates a chip set or chip 1000 upon which an embodiment of the invention may be implemented. Chip set 1000 is programmed to provide account-less access via an account connector platform as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing account-less access via an account connector platform.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide account-less access via an account connector platform. The memory 1005 also stores the data associated with or generated by the execution of the inventive steps.

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing account-less access via an account connector platform. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing account-less access via an account connector platform. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide account-less access via an account connector platform. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a request from at least one client for a user login to at least one of a plurality of accounts associated with a user, wherein the plurality of accounts is associated with an account connector platform and wherein the request includes, at least in part, one or more credentials for the least one of the plurality of user accounts;
an association of an account connector token with the user, the at least one of the plurality of accounts, or a combination thereof based, at least in part, on an authentication of the one or more credentials; and
at least one determination to authenticate the at least one client to provide another user login to at least another one of the plurality of accounts based, at least in part, on the account connector token.

2. A method of claim 1, wherein the (1) data and/or (2) information and/or (3) at least one signal are further based, at least in part, on the following:
a generation of the account connector token based, at least in part, on an authentication of the client for access to the account connector platform.

3. A method of claim 2, wherein the generation of the account connector token is performed subsequent to the request or the authentication of the one or more credentials.

4. A method of claim 2, wherein the (1) data and/or (2) information and/or (3) at least one signal are further based, at least in part, on the following:
a pre-storing of the account connector token at the client prior to the request.

5. A method of claim 1, wherein the association of the account connector token with the user, the at least one of the plurality of accounts, or a combination thereof comprises:
causing, at least in part, a linking of the account connector token with at least one service token resulting from the authentication of the one or more credentials, an authentication of the at least one client to provide the another user login, or a combination thereof.

6. A method of claim 5, wherein the plurality of user accounts are associated with a key-chain account that stores the at least one service token, one or more other service tokens associated with the plurality of user accounts, or a combination thereof.

7. A method of claim 1, wherein the (1) data and/or (2) information and/or (3) at least one signal are further based, at least in part, on the following:
at least one determination that the request follows an initialization of the at least one client; and
a restoration of the at least one of the plurality of user accounts, the at least another one of the plurality user accounts, or a combination thereof to the client based, at least in part, on the authentication of the one or more credentials, an authentication of the at least one client to provide another user login, or a combination thereof.

8. A method of claim 1, wherein the (1) data and/or (2) information and/or (3) at least one signal are further based, at least in part, on the following:
at least one determination of which of the at least another one of the plurality of users accounts to link to the account connector token based, at least in part, on one or more characteristics of the at least one of the plurality of user accounts.

9. A method of claim 8, wherein the one or more characteristics include, at least in part, an account type, a service provider, a privacy policy, a security policy, or a combination thereof.

10. A method of claim 1, wherein the authentication of the one or more credentials, an authentication of the at least one client to provide another user login, or a combination thereof is performed by at least one third party service provider.

11. An apparatus comprising:
at least one processor; and
at least one memory including computer program code for one or more programs,
the at least one memory and the computer program code configured to, with the at least one processor, cause the apparatus to perform at least the following,
determine a request from at least one client for a user login to at least one of a plurality of accounts associated with a user, wherein the plurality of accounts is associated with an account connector platform and wherein the request includes, at least in part, one or more credentials for the least one of the plurality of user accounts;
cause, at least in part, an association of an account connector token with the user, the at least one of the plurality of accounts, or a combination thereof based, at least in part, on an authentication of the one or more credentials; and
determine to authenticate the at least one client to provide another user login to at least another one of the plurality of accounts based, at least in part, on the account connector token.

12. An apparatus of claim 11, wherein the apparatus is further caused to:
cause, at least in part, a generation of the account connector token based, at least in part, on an authentication of the client for access to the account connector platform.

13. An apparatus of claim 12, wherein the generation of the account connector token is performed subsequent to the request or the authentication of the one or more credentials.

14. An apparatus of claim 12, wherein the apparatus is further caused to:
cause, at least in part, a pre-storing of the account connector token at the client prior to the request.

15. An apparatus of claim 11, wherein the association of the account connector token with the user, the at least one of the plurality of accounts, or a combination thereof further causes the apparatus to:
cause, at least in part, a linking of the account connector token with at least one service token resulting from the authentication of the one or more credentials, an authentication of the at least one client to provide the another user login, or a combination thereof.

16. An apparatus of claim 15, wherein the plurality of user accounts are associated with a key-chain account that stores the at least one service token, one or more other service tokens associated with the plurality of user accounts, or a combination thereof.

17. An apparatus of claim 11, wherein the apparatus is further caused to:
determine that the request follows an initialization of the at least one client; and
cause, at least in part, a restoration of the at least one of the plurality of user accounts, the at least another one of the plurality user accounts, or a combination thereof to the client based, at least in part, on the authentication of the one or more credentials, an authentication of the at least one client to provide another user login, or a combination thereof.

18. An apparatus of claim 11, wherein the apparatus is further caused to:
determine which of the at least another one of the plurality of users accounts to link to the account connector token based, at least in part, on one or more characteristics of the at least one of the plurality of user accounts.

19. An apparatus of claim 18, wherein the one or more characteristics include, at least in part, an account type, a service provider, a privacy policy, a security policy, or a combination thereof.

20. An apparatus of claim 11, wherein the authentication of the one or more credentials, an authentication of the at least one client to provide another user login, or a combination thereof is performed by at least one third party service provider.

21.-48. (canceled)
